(19) United States
(12) Patent Application Publication
(10) Pub. No.: US 2009/0085742 A1
(43) Pub. Date: Apr. 2, 2009

(54) Apparatus and Method for Programming Identifiers on Print Media

(76) Inventors: Eric Beard, Lexington, KY (US); Will Warner, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/863,589

(22) Filed: Sep. 28, 2007

(51) Int. Cl. G08B 13/14

(52) U.S. Cl. 340/572.1

(57) ABSTRACT

The present disclosure relates to the programming an identifier, such as an RFID tag on a sheet of print media. In the event of an unsuccessfully programmed tag, it may be reprogrammed onto the same or subsequent sheet of print media. A determination may also be made as to whether or not the reprogramming on the same or a subsequent sheet of media requires shifting of the programming originally intended for the same or subsequent sheet of media. In addition, the reprogramming may take place on print media at the completion of a particular print job.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates to printers and printing systems. More particularly, the disclosure relates to an apparatus and method for reprogramming an identifier, such as an RFID tag, on print media.

2. Description of the Related Art

Inkjet and laser printers are common in most workplace and home computing environments. Today, many printers are multi-functional assemblies capable of printing on a large array of print media including letterhead, paper envelopes and labels. A recent innovation in the printing industry involves the manufacturing of print media with embedded radio frequency signatures in the form of Radio Frequency Identification (RFID) transponders or tags. These tags, sometimes called “Smart Labels”, may be used with a variety of existing printing methods.

Embedded print media may include a backing material (sometimes referred to as the “web”) upon which a label is applied, with a RFID tag sandwiched in between the label and the backing material. There may be one or more labels on the web and the sheet, as presented, may be part label and part plain paper. In some cases there may be more than one tag arrayed across the width and down the length of the media such that multiple columns and/or rows of tags are contained on the print media.

Printing on media with embedded RFID tags is rapidly becoming a growing area of label printing. Each tag on a sheet may be printed with certain data, and the RFID tag embedded within that media may be used to allow individualized processing of user associated data. For example, a shipping label might have the delivery address and a package tracking ID printed on it, while the corresponding tag would be programmed with the same information. The delivery information may then be read from the tag, whether or not the package is positioned so that the tag is visible.

Occasionally, the programming of RFID tags is not 100% successful. For example, a situation may arise in which a sheet of media may include a number of tags, not all of which are successfully programmed. In this situation, a substitute tag including the same information intended for the failed tag or tags must be created. This may require the resubmission of the entire sheet of media having the data intended for the initial attempt. However, it is possible that one of the RFID tags on this reprinted sheet may fail again. Further, reprinting the entire sheet of media may be cost-prohibitive as it may produce a large number of duplicative tags.

### SUMMARY OF THE DISCLOSURE

In accordance with one exemplary embodiment, the present disclosure relates to a a method for programming at least one identifier onto a sheet n of print media, wherein n is an integer. This may then be followed by determining the presence of at least one unsuccessfully programmed identifier on the sheet n of print media. One may then re-program the at least one unsuccessfully programmed identifier onto a subsequent sheet of print media, where the subsequent sheet of media includes one or a plurality of identifiers for programming. In addition, the method also includes determining if such reprogramming of the at least one unsuccessfully programmed identifier, on the subsequent sheet of print media, requires shifting of the programming for at least one identifier originally targeted for programming onto the subsequent sheet of print media. If it is determined that such a program shift is required, the identifier originally targeted for programming on the subsequent sheet of media may be programmed onto a different sheet of media.

In accordance with another exemplary embodiment, the present disclosure again relates to a method for programming at least one identifier from a print job onto one or a plurality of sheets of print media containing one or more identifiers for programming. The method may include determining the presence of at least one unsuccessfully programmed identifier on the one or plurality of sheets of print media and retaining in memory the correct programming for the at least one unsuccessfully programmed identifier. This may then be followed by re-programming only the at least one unsuccessfully programmed identifier onto print media at the completion of said print job.

In another exemplary embodiment, the present disclosure relates to an article comprising a storage medium having stored thereon instructions that when executed by a machine result in the following: programming at least one identifier onto a sheet n of print media, wherein n is an integer; determining the presence of at least one unsuccessfully programmed identifier on the sheet n of print media; re-programming the at least one unsuccessfully programmed identifier onto a subsequent sheet of print media; wherein the subsequent sheet of media includes one or a plurality of identifiers for programming; and determining if the reprogramming of the at least one unsuccessfully programmed identifier on the subsequent sheet of print media requires shifting programming for at least one identifier targeted for programming onto the subsequent sheet of print media.

In another exemplary embodiment, the present disclosure relates to an article comprising a storage medium having stored thereon instructions that when executed by a machine result in the following: programming at least one identifier from a print job onto one or a plurality of sheets of print media containing one or more identifiers for programming; determining the presence of at least one unsuccessfully programmed identifier on the one or plurality of sheets of print media; retaining in memory the correct programming for the at least one unsuccessfully programmed identifier; and re-programming only the at least one unsuccessfully programmed identifier onto print media at the completion of the print job.

In another exemplary embodiment, the present disclosure relates to a method comprising programming at least one identifier onto a sheet of print media wherein the print media includes y identifiers for programming, wherein y is an integer. This may then be followed by determining the presence of at least one unsuccessfully programmed identifier on the sheet of print media and determining the number of identifiers z to be programmed to such sheet of print media, where z is an integer as well as determining whether y>z. This may then be followed by re-programming the at least one unsuccessfully programmed identifier onto the sheet of print media when y>z.

In yet another exemplary embodiment, the present disclosure relates to an article comprising a storage medium having stored thereon instructions that when executed by a machine result in the following: programming at least one identifier onto a sheet of print media wherein the print media includes y identifiers for programming, wherein y is an integer, determining the presence of at least one unsuccessfully programmed identifier on the sheet of print media. This may then be followed by determining the number of identifiers z to be programmed to said sheet of print media, where z is an integer and determining whether y>z and re-programming the at least one unsuccessfully programmed identifier onto said sheet of print media when y>z.

### BRIEF DESCRIPTION OF THE DRAWINGS

The above-mentioned and other features and advantages of this disclosure, and the manner of attaining them, will become more apparent and the disclosure will be better understood by reference to the following description of embodiments of the disclosure taken in conjunction with the accompanying drawings, wherein:

FIG. 1 is a block diagram of an embodiment of an exemplary printing system in accordance with the present disclosure;

FIG. 2 is a block diagram of another exemplary embodiment of a printing system showing in greater detail a portion of a printing system having radio frequency components;

FIG. 3 is a diagram of yet another exemplary embodiment of the present disclosure depicting a print job having failed RFID identifiers;

FIG. 4 is a diagram of an additional exemplary embodiment of the present disclosure depicting the resubmission of a print job having failed RFID identifiers;

FIG. 5 is a diagram of yet another exemplary embodiment of the present disclosure depicting the resubmission of a print job having failed RFID identifiers; and

FIG. 6 is a flow diagram showing an exemplary method in accordance with the present disclosure

FIG. 7 is a flow diagram showing another exemplary method in accordance with the present disclosure.

FIG. 8 is a diagram of an additional exemplary embodiment of the present disclosure depicting the resubmission of a print job having a failed identifier on a particular sheet of print media.

### DETAILED DESCRIPTION

It is to be understood that this disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

For simplicity the discussion below will use the terms “media”, “sheet” and/or “paper” to refer to a discrete unit of media. It should be understood, however, that this term is not limited to paper sheets, and any form of discrete media is intended to be encompassed therein, including without limitation, envelopes, transparencies, postcards, labels, and the like. The disclosure herein also applies to printing devices such as an electrophotographic printer, an inkjet printer, a fax device, a copier, an all-in-one device, an RFID printer or a multipurpose device.

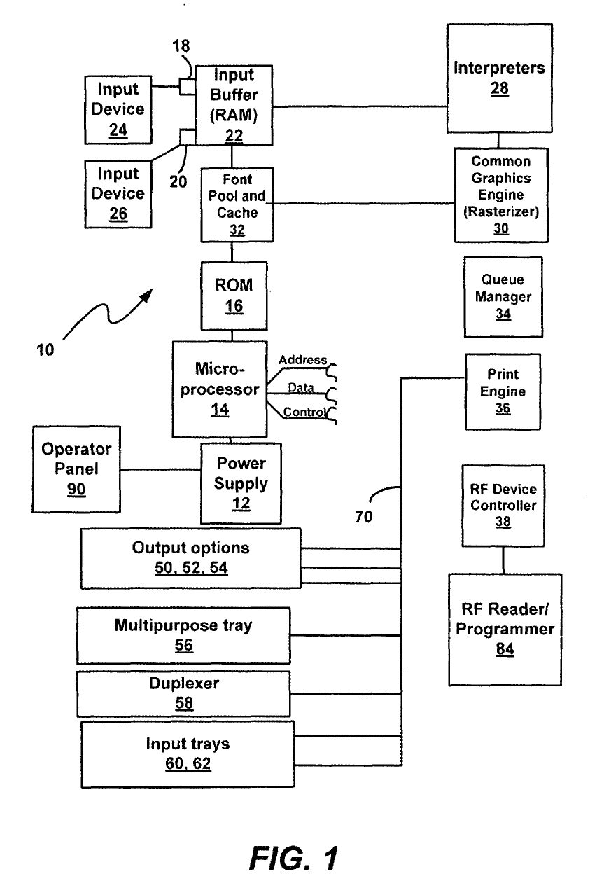

Referring now to the drawings, FIG. 1 shows a hardware block diagram of an exemplary printing system, generally designated by the reference numeral 10, which may be used in accordance with the methods described herein. Printing system 10 may contain certain components, such as a DC power supply 12 that may have multiple outputs of different voltage levels, a microprocessor 14 having address lines, data lines, and control and/or interrupt lines, Read Only Memory (ROM) 16, and Random Access Memory (RAM), which may be divided by software operations into several portions for performing several different functions.

Printing system 10 may also contain at least one serial input or parallel input port, network or USB port, or in many cases several types of input ports, as designated by the reference numeral 18 for the serial port and the reference numeral 20 for the parallel port. Each of these ports 18 and 20 may be connected to a corresponding input buffer, generally designated by the reference numeral 22 on FIG. 1. Serial port 18 may be connected to a serial output port of a personal computer or a workstation that may contain a software program such as a word processor or a graphics package or computer aided drawing package. Similarly, parallel port 20 may be connected to a parallel output port of the same type of personal computer or workstation containing similar types of programs. Such input devices are designated, respectively, by the reference numerals 24 and 26 on FIG. 1.

Once the text or graphical data has been received by input buffer 22, it may be communicated to one or more interpreters designated by the reference numeral 28. A common interpreter is PostScript™, which is an industry standard used by some laser printers. After being interpreted, the input data may be sent to a common graphics engine to be rasterized, which may occur in a portion of RAM designated by the reference numeral 30 on FIG. 1. To speed up the process of rasterization, a font pool and possibly also a font cache may be stored, respectively, in ROM or RAM within most laser printers, and these font memories are designated by the reference numeral 32 on FIG. 1. Such font pools and caches may supply bitmap patterns for common alphanumeric characters so that the common graphics engine 30 can easily translate each such character into a bitmap using a minimal elapsed time.

Once the data has been rasterized, it may be directed into a Queue Manager or page buffer, which may be a portion of RAM designated by the reference numeral 34. In a typical laser printer, an entire page of rasterized data may be stored in the Queue Manager during the time interval that it takes to physically print the hard copy for that page. The data within the Queue Manager 34 may be communicated in real time to a print engine designated by the reference numeral 36. Print engine 36 may include a laser light source within its printhead (not shown), and its output may be the physical marking on a piece of paper, which may be the final print output from printing system 10.

In some embodiments, the address, data, and control lines may be grouped in buses, which are electrically conductive pathways that are physically communicated in parallel (sometimes also multiplexed) around the various electronic components within printing system 10. For example, the address and data buses may be sent to all ROM and RAM integrated circuits and the control lines or interrupt lines may be directed to all input or output integrated circuits that act as buffers.

Print engine 36 may contain the core print circuitry which may be embodied in an Application Specific Integrated Circuit (ASIC) (not shown), for example, and which may act as the printing device's primary controller and data manipulating device for the various hardware components within the print engine 36. The bitmap print data arriving from Queue Manager 34 may be received by the core print circuitry, and at the proper moments may be sent in a serialized format to the laser printhead.

The print engine 36 may be in communication with a number of paper-handling devices via a communications bus 70. Some of the paper-handling devices depicted on FIG. 1 may include output options 50, 52, 54, a multipurpose tray 56, a duplexer 58, and input trays 60 and 62. The output options may vary depending on the particular finish functionality provided by the printing system 10. Examples of output options may include, but are not limited to, a single output bin, a 5-bin multi-bin stacker and/or a single bin stapler finishing option.

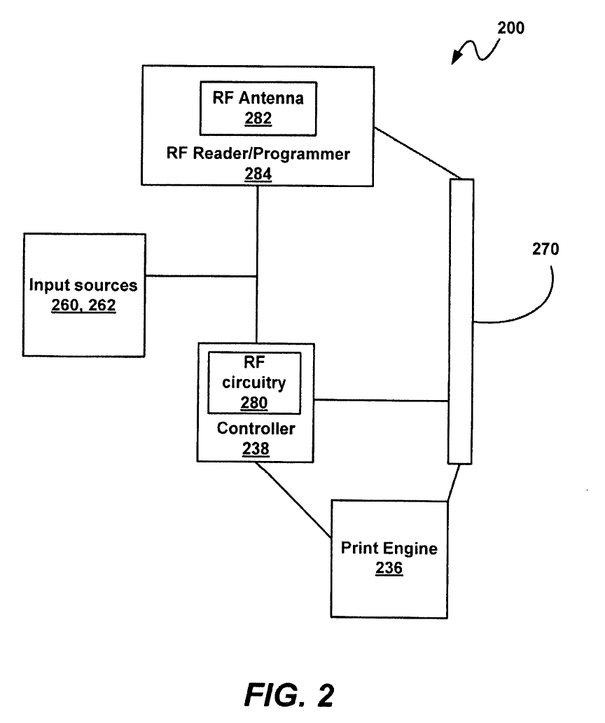

Print engine 36 may also be coupled to and/or in communication with a number of RFID devices. For example, an RF device controller 38 may be included that may be configured to communicate and/or control a variety of RF devices associated with system 10. One such device may be an RF reader/programmer 84, which is discussed in further detail below with reference to FIG. 2.

Each input tray 60, 62 may be configured to hold media, which may contain one or more identifiers. An identifier as described herein may therefore be understood to include, e.g., an RFID transponder, an RFID tag (e.g., active, passive and/or semi-passive), a “smart card”, a “smart label”, a microchip/antenna package, a “chipless” RFID tag, or any other programmable identification device. A “chipless” RFID tag (e.g., RF fibers) may not utilize any integrated circuit technology to store information. The tag may also use fibers or materials that reflect a portion of a reader's signal back and such unique return signal may then be used as for identification purposes.

It may therefore be appreciated that within each input tray, and as between input trays, the media may have different types of RFID tags, each intended to have, or having, its own programmed data which tag may then communicate via the use of radio waves. Furthermore, as noted above, the RFID tags may differ with respect to whether or not the tags are a passive tag, which may be understood as those tags that are ultimately powered by an RFID reader/programmer, or an active tag, in which case the RFID tag may have its own power source. Passive RFID tags may make use of a coiled antenna that may create a magnetic field using the energy provided by the reader's carrier signal. The RFID tags may also be a semi-passive tag, which have a power source (e.g. a laminar, flexible relatively low cost battery) which may be used for on tag sensing. The RFID tags may also be a read only tag that contains a unique programming that cannot be changed, or a write once read many (WORM) tag that may enable users to encode tags at the first instance of use wherein the code may then become locked. The RFID tags may also be a read/write tag that allows for updated or new information to be written to the tag. As discussed more fully below, printing system 10 may be configured to determine whether an RFID identifier has been programmed successfully and, if not, how to efficiently reprogram the identifier.

Within each input tray 60, 62, and as between input trays, the media may have a different number of tags. With respect to media having the same number of tags, the tags may be arranged at different locations. For example, one media type may have a single tag located in the center of the page near the leading edge. A different media type may have two tags, one in the upper left corner and the other at mid-page on the right side. It may also be appreciated that as between input trays, the nature of the media in which the RFID tags may be embedded may differ. For example, the media may be paper, label, cardstock, transparencies, etc. System 10 may be used to select a media input source (e.g., trays 60 and/or 62) for printing RFID media. Although only two input trays are shown, it is contemplated that any number of input sources may be used in accordance with the present disclosure.

Printing system 10 may also include at least one paper or other type of print media positioning sensor. In some cases, the paper positioning sensors may be optoelectronic devices, which have a light source that may be a light emitting diode (LED). This may allow for sensing the position of a sheet of paper or other print media and may provide a method of determining when the leading edge or trailing edge of a sheet of print media has reached a particular point along the media pathway. Furthermore, many different types of sensors may be used other than optoelectronic devices (e.g., a limit switch to detect whether or not the printer cover is closed) without departing from the principles of the present disclosure.

FIG. 2 illustrates an exemplary embodiment showing further detail of a printing system 200 including RFID components. System 200 may include a print engine 236, a controller 238, communications bus 270 a RF reader/programmer 284 and/or an operator panel (not shown). RFID reader/programmer 284 may be used to interrogate an identifier, such as an RFID tag. Reader/programmer 284 may include an antenna 282 that may emit radio waves of various frequencies. RF antenna 282 may be a conductive element that may be used by RF reader/programmer 284 to read and/or program an identifier (e.g., a radio frequency device tag) as well as to confirm whether an identifier is working or defective. Antenna 282 may be in communication with an identifier, which may respond by transmitting data back to antenna 282. This data may be transmitted in accordance with a variety of different communication protocols having different frequency ranges. A number of factors may affect the distance at which a tag can be read (i.e., the read range). The frequency used for identification, the antenna gain, the orientation and polarization of the reader antenna and the transponder antenna, as well as the placement of the identifier on an object to be identified may all have an impact on the read range of system 200.

In some embodiments, radio frequency control circuitry 280 may attempt to read and/or program a tag embedded in the media and then note the success or failure of this attempt. The radio frequency control circuitry 280 may then monitor or “listen” on its communications port to track the page's location as it moves through the printer. It is contemplated that controller 238 may be packaged into an aftermarket option that may be installed in a printer, such as printing device 10, without modification of the printer's other essential systems such as print engine 236 including the core print logic.

Printing device 10 may include test routines that may be capable of detecting certain failures or errors within printing device 10. Some of these errors may include, but are not limited to, an inability to communicate with RF reader/programmer 284, or an indication of a problem with antenna 282 forwarded from reader/programmer 284. Printing device 10 may include firmware having check routines that may validate the data passed down from a print job, wherein a print job may be understood as a selected amount of data that is targeted for a given amount of print media. These check routines may also be capable of detecting instances of data corruption or other internal errors. If an error is detected an error message may be presented to operator panel 290, which may present descriptive debug information for a repair technician.

With the above in mind, it is now useful to point out that a computer running a host application may be connected to a printer, such as that shown in FIG. 1. The host application may be configured to specify the location and type of identifier on a given sheet of media. Bi-directional communication between the printer and computer may be established. In some embodiments, the host may submit a print job and identify the RFID information for each identifier. This may allow the printer to determine the data that needs to be written to each identifier (e.g., RFID tag). A number of different techniques may be employed in order to determine whether or not an identifier has been successfully programmed.

For example, in one embodiment, if the printer fails to properly program a tag, an asynchronous event may be transmitted back to the host. This event may initially contain the page identifier of the tag that failed to print. This event may be transmitted via a number of different communication mechanisms, including, but not limited to, network protocol alliance (NPA) and printer job language (PJL). The printer may then send an event to the host in order to indicate that the page has been completed.

Accordingly, as each identifier is programmed, an asynchronous event may also be sent back to the host. This event may contain the page identifier of the particular identifier that may have been unsuccessfully programmed as well as information concerning precisely which identifier may have been unsuccessfully programmed on the indicated page. After the printer has confirmed programming of the final identifier for a given print job, the host may then establish and report to a user that such final page has been completed. However, in that situation where it has been recognized that one or more identifiers have not been successfully programmed, the system may now reprogram such identifiers as described in further detail below.

For example, the host may wait until it has verified which identifiers for a particular page have been successfully programmed before composing the next page. In this embodiment, the host may then resubmit the unsuccessfully programmed identifiers on the very next page that is sent form the host for printing. It therefore can be readily appreciated that this may then allow a user to specifically locate the unsuccessfully programmed identifiers on a next page rather than at the end of the entire print job. In addition, as explained more fully below, the host may resubmit the unsuccessfully programmed identifiers on the last page of the print job, and the system herein may therefore, in either situation, reduce the number of pages of identifiers that may require programming.

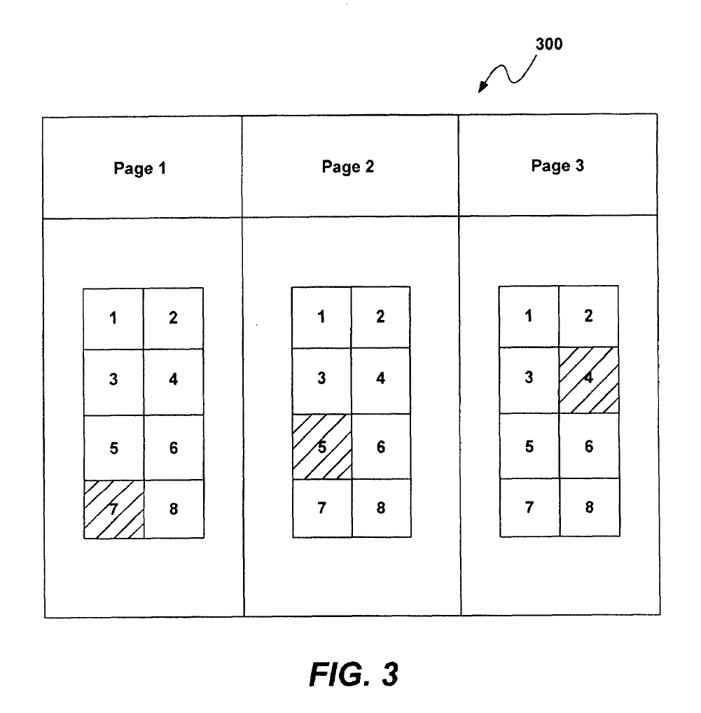

Referring now to FIGS. 3-5, exemplary embodiments of the present disclosure are provided showing methods for reprogramming at least one failed identifier on a sheet of print media. FIG. 3 shows at 300 three distinct sheets of media, each having a plurality of identifiers. The identifiers may be positioned in a number of different configurations upon each sheet of media. For example, the identifiers may be positioned in increasing order from left to right and top to bottom as shown in FIG. 3. Of course, the identifiers may be arranged in any order and the printing device and software may then be configured to utilize the same approach. FIG. 3 shows three distinct pages of media each having an unsuccessfully programmed identifier (i.e., page 1-identifier 7 or “P1-7”, page 2-identifier 5 or “P2-5” and page 3-identifier 4 or “P3-4”). According to prior techniques, the unsuccessful programming illustrated in FIG. 3 will lead to the need to reprint all three (3) pages.

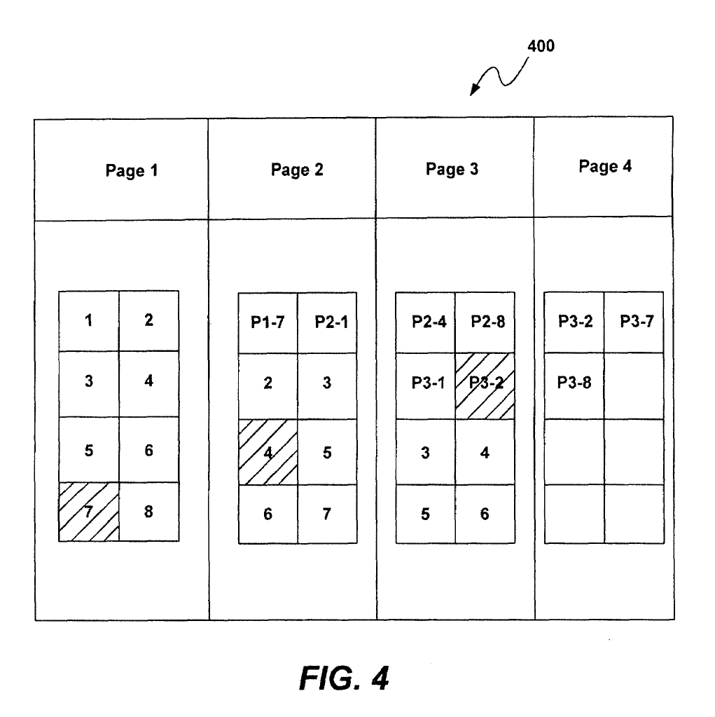

Referring now to FIG. 4, one exemplary embodiment of the present disclosure is now provided shown generally at 400. In this embodiment, the host may receive notification that page 1 includes an unsuccessfully programmed identifier number 7. Once the host has verified that identifier 7 has not been successfully programmed it may resubmit identifier 7 on page 2. As can be seen, page 2 in FIG. 4 now includes successfully programmed identifier 7 from page 1 (i.e. P1-7) in the upper left hand corner with the page 2 identifier 1 shifted to the immediate right (i.e. P2-1) along with the remaining identifiers for programming.

However, page 2 may itself include one or more failed identifiers, such as identifier 4 shown in FIG. 4. This identifier may also be resubmitted and re-programmed on page 3 and appears as “P2-4.” As can now be seen, the addition of identifier P1-7 on page 2 may of course result in what may be termed herein an overflow or shift condition and identifier P2-8 originally intended for page 2 may now be shifted and programmed on page 3 followed by at least a portion of the identifiers originally scheduled for page 3 (as shown P3-1, unsuccessfully programmed identifier P3-2, and page 3 identifiers numbered 3-6). Accordingly, page 4 is shown, which now includes successfully programmed identifier P3-2 along with shifted identifiers P3-7 and P3-8. As can therefore be seen from this representative example, in that situation where there are three failed programming events of the indicated identifiers (i.e. P1-7, P2-4 and P3-2), across three separate pages, only one additional page is necessary to correct such unsuccessful identifier programming manufacture.

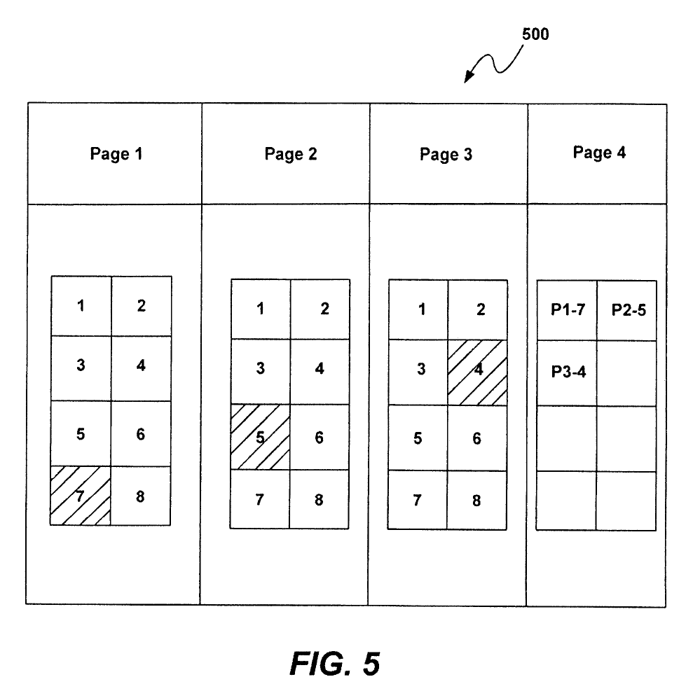

In another exemplary embodiment, the host may obtain the information regarding all of the unsuccessfully programmed identifiers across various pages and resubmit these identifiers at the end of the print job. FIG. 5 depicts at 500 such exemplary embodiment wherein the host may receive a notification that page 1-identifier 7 (P1-7), page 2-identifier 5 (P2-5) and page 3-identifier 4 (P3-4) have not been successfully programmed. The host program may then resubmit all three of the failed identifiers on page 4. Once again, in this approach, the total number of pages required may be reduced and all of the failed identifiers may be included on a single page or a reduced number of pages.

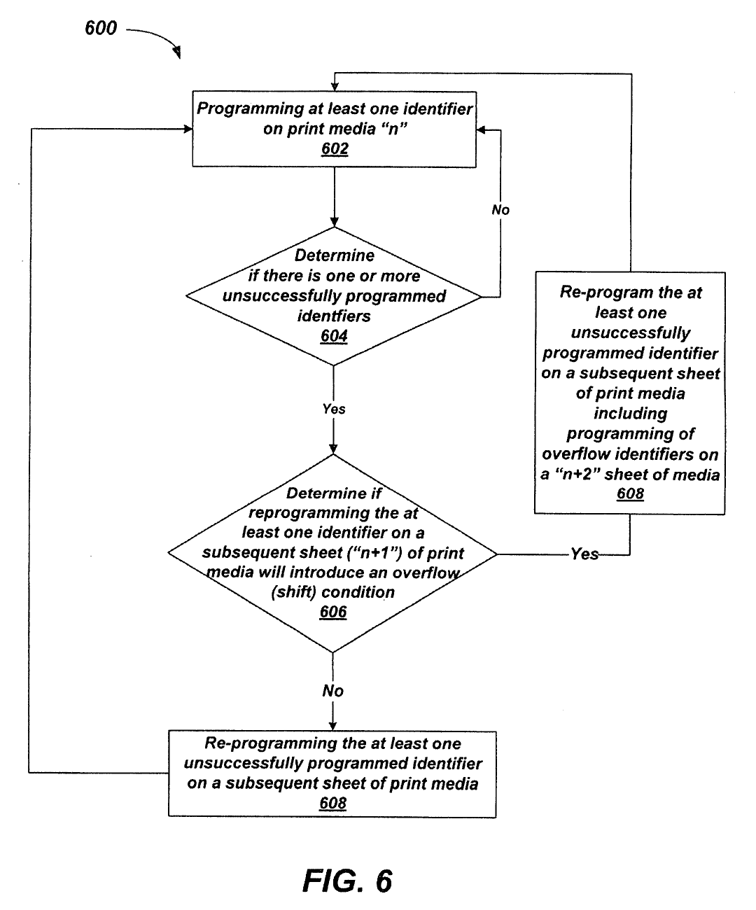

FIG. 6 provides a descriptive flow diagram 600 of an exemplary operation of the present disclosure alluded to above. As illustrated, the method may include programming at 602 at least one identifier, e.g. an RFID tag, on a sheet “n” of print media, wherein n is an integer, other than zero, e.g., 1, 2, 3, etc. The method may further include determining at 604 whether or not there is one or more unsuccessfully programmed identifiers, which may be understood herein as determining that any given identifier does in fact include all or a portion of the intended programming data it was to receive during a given programming (writing) operation. If “yes” the method may then determine at 606 if reprogramming the at least one identifier on a subsequent (e.g. n+1) sheet of print media will introduce an overflow or shift condition (i.e., as noted above, the need to shift the identifiers originally intended for one page to a different page). Accordingly, in the context of FIG. 6, this may also be understood as that situation wherein the reprogramming of the identifier on the subsequent sheet of media will not provide for all identifiers originally intended for the “n+1” page to be programmed thereon. If the reprogramming will therefore introduce an overflow (shift) condition, at 608 the reprogramming of the at least one unsuccessfully programmed identifier may proceed including programming of overflow identifier(s) on an “n+2” sheet of media. If the reprogramming will not introduce an overflow condition, at 610 the method may then simply reprogram the at least one unsuccessfully programmed identifier on a subsequent sheet of print media and be configured for further programming as desired.

Accordingly, it may now be appreciated that the method herein may determine if reprogramming of at least one unsuccessfully programmed identifier on a subsequent sheet of print media will require shifting of the programming for any one of those identifiers originally targeted for such subsequent sheet of print media. This may then be followed by programming such originally (and now shifted) targeted identifier onto an entirely different sheet of print media, which different sheet of media may be a n+2 sheet of media, or even some other sheet of media (e.g. n+3, n+4, n+5, etc.) within a given print job.

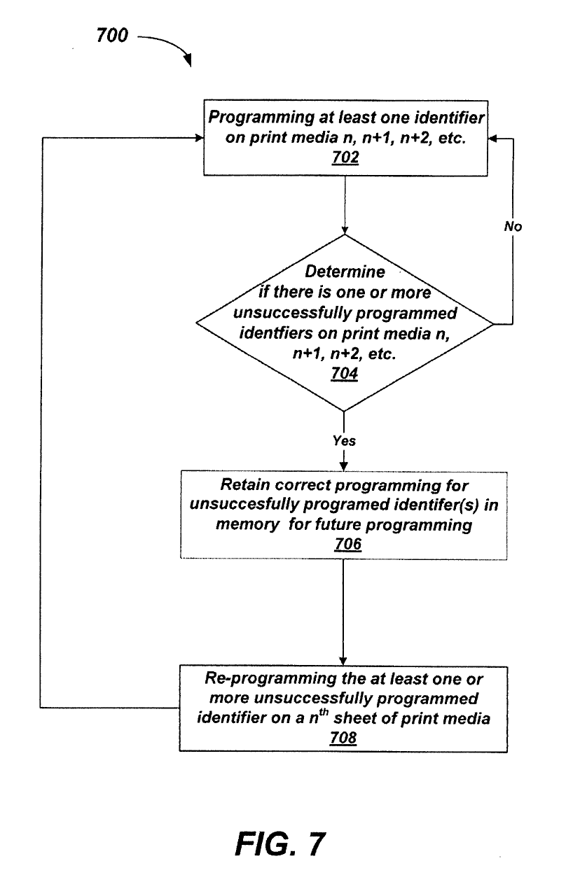

FIG. 7 provides another descriptive flow diagram 700 of an exemplary operation of the present disclosure also alluded to above. At 702 the method may include programming of at least one identifier onto a sheet of print media n, n+1, n+2, etc. This may then be followed by determining if there is one or more unsuccessfully programmed identifiers on print media n, n+1, n+2, etc. If “yes”, at 706, the correct programming for such unsuccessfully programmed identifier may be retained in memory and at 708 any of the unsuccessfully programmed identifiers may be programmed onto an n^{th} sheet of print media, which may include the last page of print media for a given programming sequence. Accordingly, only the earlier and unsuccessfully programmed identifiers are re-programmed onto a last page of print media without the need to reprogram any of the successfully programmed identifiers. In addition, if the decision is “no” at 706, the operation may continue to program the identifiers as originally intended.

In a still further exemplary embodiment of the present disclosure, one may again program at least one identifier onto a particular sheet of print media, wherein the print media is such that it may include y tags available for programming, wherein y is an integer. The method may then determine the presence of at least one or more unsuccessfully programmed identifiers on the sheet of print media. The method may then also determine, for a given number of identifiers z to be programmed to the particular sheet of media, whether or not there remains a sufficient number of identifiers available for programming (i.e. y tags) so that the unsuccessfully programmed identifier may be programmed onto such sheet of print media. For example, if there remains a sufficient number of identifiers available for programming (i.e. y>z) then one may select an available identifier for reprogramming of the unsuccessfully programmed identifier onto the particular sheet of print media. This may therefore be accomplished rather than shifting the reprogramming of the unsuccessfully programmed identifier to a subsequent sheet of print media, containing one or a plurality of identifiers for programming. Such shifting may therefore be required when y is less than or equal to z (i.e. y≦z).

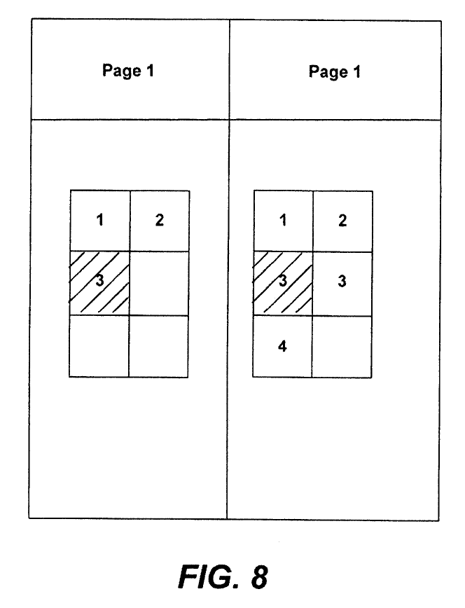

Attention is therefore directed to FIG. 8. As can be seen, the particular sheet of print media (Page 1) contains 6 identifiers that are available for programming, and the value of y, as noted above, would be equal to 6. In this example, four identifiers are targeted for programming on Page 1, and the value of z, as also noted above, would then be equal to 4. However, it is determined that identifier number 3 was unsuccessfully programmed. As there remains a sufficient number of identifiers available for programming on Page 1 (i.e. y>z), as shown on the right hand side of FIG. 8, identifier number 3 is then programmed onto Page 1 and identifier number 4 is shifted and programmed on the next available identifier and/or to any available identifier location on Page 1.

With regards to any of the features noted above, it should also contemplated herein that whenever there is identification of an unsuccessfully programmed identifier, one may provide that the printer mark such unsuccessfully programmed identifier (e.g. a visible mark) so that the user may be informed that such identifier may not be suitable for use. In this manner, the user may then await for the re-programming of the identifier on a subsequent sheet of media in a manner as described herein.

Furthermore, as used in any embodiment described herein, suitable “circuitry” for the host and printers noted herein may comprise, for example, singly or in any combination, hardwired circuitry, programmable circuitry, state machine circuitry, and/or firmware that stores instructions executed by programmable circuitry. It should be understood at the outset that any of the operations and/or operative components described in any embodiment herein may be implemented in software, firmware, hardwired circuitry and/or any combination thereof.

It should now also be clear that embodiments of the methods described above may be implemented in a computer program that may be stored on a storage medium having instructions to program a system to perform the methods. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

It should be understood that modifications can be made to the disclosure in light of the above detailed description. The terms used in the following claims should not be construed to limit the disclosure to the specific embodiments disclosed in the specification and the claims. Rather, the scope of the disclosure is to be determined entirely by the following claims, which are to be construed in accordance with established doctrines of claim interpretation.

What is claimed is:

1. A method comprising:
programming at least one identifier onto a sheet n of print media, wherein n is an integer;
determining the presence of at least one unsuccessfully programmed identifier on said sheet n of print media;
re-programming the at least one unsuccessfully programmed identifier onto a subsequent sheet of print media, wherein said subsequent sheet of media includes one or a plurality of identifiers for programming; and
determining if said reprogramming of the at least one unsuccessfully programmed identifier on said subsequent sheet of print media requires shifting programming for at least one identifier targeted for programming onto said subsequent sheet of print media.

2. The method of claim 1 including programming the at least one identifier, targeted for programming onto said subsequent sheet of print media, onto a different sheet of print media.

3. The method of claim 1, including programming the at least one identifier, targeted for programming onto said subsequent sheet of print media, onto said subsequent sheet of print media.

4. The method of claim 1 including reprogramming the at least one unsuccessfully programmed identifier onto an n+1 sheet of print media.

5. The method of claim 1, wherein determining at least one unsuccessfully programmed identifier is performed via a communication mechanism selected from the group consisting of network protocol alliance (NPA), printer job language (PJL) and simple network management protocol (SNMP).

6. The method of claim 1 wherein said identifier is an RFID transponder.

7. The method of claim 1 including marking said unsuccessfully programmed identifier on said sheet of print media.

8. The method of claim 1 wherein said method occurs in a printer.

9. A method comprising:
programming at least one identifier from a print job onto one or a plurality of sheets of print media containing one or more identifiers for programming;
determining the presence of at least one unsuccessfully programmed identifier on said one or plurality of sheets of print media;
retaining in memory the correct programming for said at least one unsuccessfully programmed identifier; and
re-programming only the at least one unsuccessfully programmed identifier onto print media at the completion of said print job.

10. The method of claim 9, wherein determining at least one unsuccessfully programmed identifier is performed via a communication mechanism selected from the group consisting of network protocol alliance (NPA), printer job language (PJL) and simple network management protocol (SNMP).

11. The method of claim 9 wherein said identifier is an RFID transponder.

12. The method of claim 9 including marking said unsuccessfully programmed identifier on said sheet of print media.

13. The method of claim 9 wherein said method occurs in a printer.

14. An article comprising a storage medium having stored thereon instructions that when executed by a machine result in the following:
programming at least one identifier onto a sheet n of print media, wherein n is an integer;
determining the presence of at least one unsuccessfully programmed identifier on said sheet n of print media; and
re-programming the at least one unsuccessfully programmed identifier onto a subsequent sheet of print media, wherein said subsequent sheet of media includes one or a plurality of identifiers for programming; and
determining if said reprogramming of the at least one unsuccessfully programmed identifier on said subsequent sheet of print media requires shifting programming for at least one identifier targeted for programming onto said subsequent sheet of print media.

15. The article of claim 14, wherein said instructions, when executed by a machine, result in the following:
programming the at least one identifier, targeted for programming onto said subsequent sheet of print media, onto a different sheet of print media.

16. The article of claim 14, wherein said instructions, when executed by a machine, result in the following:
programming the at least one identifier, targeted for programming onto said subsequent sheet of print media, onto said subsequent sheet of print media.

17. The article of claim 14 wherein the identifier is an RFID transponder.

18. The article of claim 14, wherein said article is located in a printer.

19. An article comprising a storage medium having stored thereon instructions that when executed by a machine result in the following:
programming at least one identifier from a print job onto one or a plurality of sheets of print media containing one or more identifiers for programming;
determining the presence of at least one unsuccessfully programmed identifier on said one or plurality of sheets of print media;
retaining in memory the correct programming for said at least one unsuccessfully programmed identifier; and
re-programming only the at least one unsuccessfully programmed identifier onto print media at the completion of said print job.

20. The article of claim 19 wherein said identifier is an RFID transponder.

21. The article of claim 19, wherein said article is located in a printer.

22. A method comprising:
programming at least one identifier onto a sheet of print media wherein the print media includes y identifiers for programming, wherein y is an integer;
determining the presence of at least one unsuccessfully programmed identifier on said sheet of print media;
determining the number of identifiers z to be programmed to said sheet of print media, where z is an integer and whether y>z;
re-programming the at least one unsuccessfully programmed identifier onto said sheet of print media when y>z.

23. The method of claim 22, wherein, when y is not greater than z, supplying a subsequent sheet of media including one or more identifiers for programming and shifting programming of said unsuccessfully programmed identifier to said subsequent sheet of media.

24. An article comprising a storage medium having stored thereon instructions that when executed by a machine result in the following:
programming at least one identifier onto a sheet of print media wherein the print media includes y identifiers for programming, wherein y is an integer;
determining the presence of at least one unsuccessfully programmed identifier on said sheet of print media;
determining the number of identifiers z to be programmed to said sheet of print media, where z is an integer and whether y>z;
re-programming the at least one unsuccessfully programmed identifier onto said sheet of print media when y>z.

25. The article of claim 24, wherein said instructions, when executed by a machine, result in the following:
when y is not greater than z, shifting programming of said unsuccessfully programmed identifier to a subsequent sheet of media.
